(19) United States
(12) Patent Application Publication
(10) Pub. No.: US 2009/0289843 A1
(43) Pub. Date: Nov. 26, 2009

(54) Method and System for Rendering Changing GPS Position on a Web Page

(76) Inventor: Parakrama JAYASINGHE, Rajagiriya (LK)

Correspondence Address: MOTOROLA, INC., 1303 EAST ALGONQUIN ROAD, IL01/3RD, SCHAUMBURG, IL, 60196, US

(21) Appl. No.: 12/125,515

(22) Filed: May 22, 2008

(51) Int. Cl. G01S 1/00

(52) U.S. Cl. 342/357.07

(57) ABSTRACT

Described is a method including receiving initial location values of an asset within a monitored region, inserting the initial location values into a web-based document, and rendering an initial position of an icon on the web-based document. Further described is a device including a communication interface receiving initial location values of an asset within a monitored region, a display displaying an image of the monitored region, and a processor inserting the initial location values into a web-based document and rendering an initial position of an icon on the web-based document. The icon represents a location of the asset within the monitored region.

### FIELD OF INVENTION

The present application generally relates to systems and methods for rendering changing positions of global positioning system (“GPS”) asset within a web page. Specifically, the present invention is related to systems and methods for utilizing location data within web-based applications on mobile computing devices.

### BACKGROUND

A global positioning system (“GPS”) is a location-aware application that provides autonomous spatial positioning data within a global coverage. A typical GPS may implement electronic receivers, such as GPS tracking devices, for determining their location (e.g., longitude, latitude, and altitude) to within a few meters using time signals transmitted along a line of sight by radio from a plurality of satellites. Therefore, GPS applications provide the ability to determine an absolute location of the receiver to allow the receiver to service as, for example, a surveying tool, a navigation aid, etc. Furthermore, the GPS application may determine relative movement to enable the receiver to calculate velocity, as well as orientation.

### SUMMARY OF THE INVENTION

The present invention relates to a method including receiving initial location values of an asset within a monitored region, inserting the initial location values into a web-based document, and rendering an initial position of an icon on the web-based document, wherein the icon represents a location of the asset within the monitored region on a display. The present invention further relates to a device including a communication interface receiving initial location values of an asset within a monitored region, a display displaying an image of the monitored region, and a processor inserting the initial location values into a web-based document and rendering an initial position of an icon on the web-based document, wherein the icon represents a location of the asset within the monitored region.

### BRIEF DESCRIPTION OF THE DRAWINGS

FIG. 1 shows an exemplary mobile computing device (“MCD”) for illustrating the changes in direction and altitude of an icon within the map image according to the present invention.

FIG. 2 shows an exemplary table for rendering a change in a GPS position on a web-based document (e.g., a web page) according to the exemplary embodiments of the present invention.

FIG. 3 shows an exemplary display for illustrating the changes in direction and altitude of an icon within an map image according to the present invention.

FIG. 4A shows an exemplary web-based document for displaying a GPS position indicator (e.g., icon) of a GPS asset on a browser according to the exemplary embodiments of the present invention.

FIG. 4B shows an exemplary web-based document for displaying position navigation of a GPS asset on a browser according to the exemplary embodiments of the present invention.

FIG. 4C shows an exemplary web-based document for displaying a speed indication of a GPS asset on a browser according to the exemplary embodiments of the present invention.

FIG. 4D shows an exemplary web-based document for displaying speed navigation of a GPS asset on a browser according to the exemplary embodiments of the present invention.

FIG. 4E shows an exemplary web-based document for displaying a date and time corresponding to a GPS asset on a browser according to the exemplary embodiments of the present invention.

FIG. 5 shows an exemplary method rendering changes in a GPS position of a GPS asset on a web browser according to the exemplary embodiments of the present invention.

### DETAILED DESCRIPTION

The exemplary embodiments of the present invention may be further understood with reference to the following description of exemplary embodiments and the related appended drawings, wherein like elements are provided with the same reference numerals. The exemplary embodiments of the present invention are related to systems and methods for rendering changing GPS position on a web page. Specifically, the present invention is related to systems and methods for utilizing location data within web-based applications on mobile computing devices.

The exemplary web-based applications may be developed through the use of any scripting languages, such as HyperText Markup Language (“HTML”), JavaScript, Extensible Markup Language (“XML”), Asynchronous JavaScript and XML (“AJAX”), as well as stylesheet languages, such as Cascading Style Sheets (“CSS”), As opposed to the standalone counterparts, web-based applications may be easily managed, easily updated, and may also be hosted remotely. Accordingly, a developer with limited knowledge of web technologies may manage to develop highly interactive web applications on a mobile computing device.

According to the exemplary embodiments of the present invention, the systems and methods may allow for web developer to render and adjust a GPS display through the use “Meta tags” or “Meta elements.” Meta tags may be described as information inserted into the HEAD section of a web page accessed from a web browser. Specifically, the Meta tag may be a HyperText Markup Language (“HTML”) element or an Extensible Hypertext Markup Language (“XHTML”) element used to provide structured metadata about the accessed web page (e.g., an HTML or XHTML document). Accordingly, Meta tags may be used to specify page description, keywords as well as any other metadata not provided through the other HEAD elements and attributes. In addition, the information contained in the HEAD section of a web page is not seen by those viewing the page. Instead, metadata in this area is used to communicate information that a human visitor may not be concerned with. For example, Meta tags may tell a browser which character set to use or instruct a web browser to automatically refresh the web page after a given time interval.

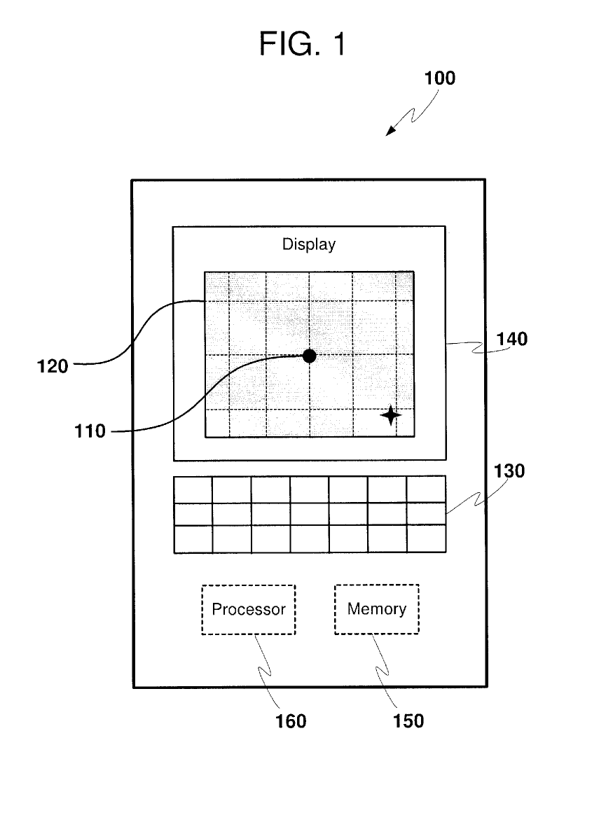

FIG. 1 shows an exemplary mobile computing device (“MCD”) 100 for illustrating the changes in direction and altitude of an icon 110 within a map image 120 according to the present invention. The exemplary MCD 100 may include a keypad 130, display 140, a memory 150, and a processor 160 and may feature any number of peripherals (e.g., automatic identification interfaces, such as but limited to bar code scanners, radio frequency identification readers (“RFID”), magnetic stripe readers (“MSR”), etc.). In addition, the exemplary MCD 100 may include an operating system as well as web browsing applications, such as Microsoft PocketIE.

It should be noted that the MCD 100, according to the present invention, may describe any mobile computing device, such as, for example, mobile telephones, personal digital assistants (“PDAs”), portable barcode scanners (i.e., laser and/or imager-based scanners), radio frequency identification (“RFID”) readers, voice over Internet protocol (“VoIP”) telephone receivers, two-way pagers, digital cameras, portable media players, laptop computers, portable gaming consoles, etc. Regardless of which type of computing device is implemented with the exemplary methods and systems of the present invention, the MCD 100 may include an interactive GPS display for tracking a GPS asset (e.g., merchandise, a vehicle, a package, an individual, etc.) by the user of the MCD 100. It should be noted that the tracked GPS asset may also be the MCD 100, itself. In other words, the MCD 100 may implement an exemplary CPS application in order to track a current location of the MCD 100. Thus, the MCD 100 may provide a user with a real-time representation of the location (e.g., latitude, longitude, altitude measurements) of the MCD 100, as well as providing additional characteristics, such as velocity and directional bearing of the MCD 100.

According to the exemplary embodiments of the present invention, the MCD 100 may include software tools, such as Motorola PocketBrowser®, that may extend the core rendering engine functionalities of the web browsing applications. Specifically, the software tools may provide an interface to the hardware and features of the MCD 100 through the use of Meta assets, or other meta elements such as Microsoft ActiveX® components, designed for the MCD 100. Therefore, the software tools may offer simple integration with the various peripherals of the MCD 100. Thus, the exemplary embodiments of the present invention may improve the development of location aware applications on the MCD 100 through the use of a GPS module.

In addition to the standard features of the web browser on the MCD 100, the software tools may allow the browser to interpret certain Meta tags (e.g., proprietary Meta tags) that would otherwise be ignored by other web browsers. For example, the software tools may include declared Meta tag attribute/value pairs to implement other available functionalities such as bar code scanners, RFID readers, MSR, COM ports, signal strength, device control, page control, Registry handling, AirBeam, printer and key capturing, etc. Thus, the MCD 100 may be readily deployed in industries such as retail, manufacturing, transportation/logistics, weather tracking, warehousing/storage, as well as healthcare and hospitality.

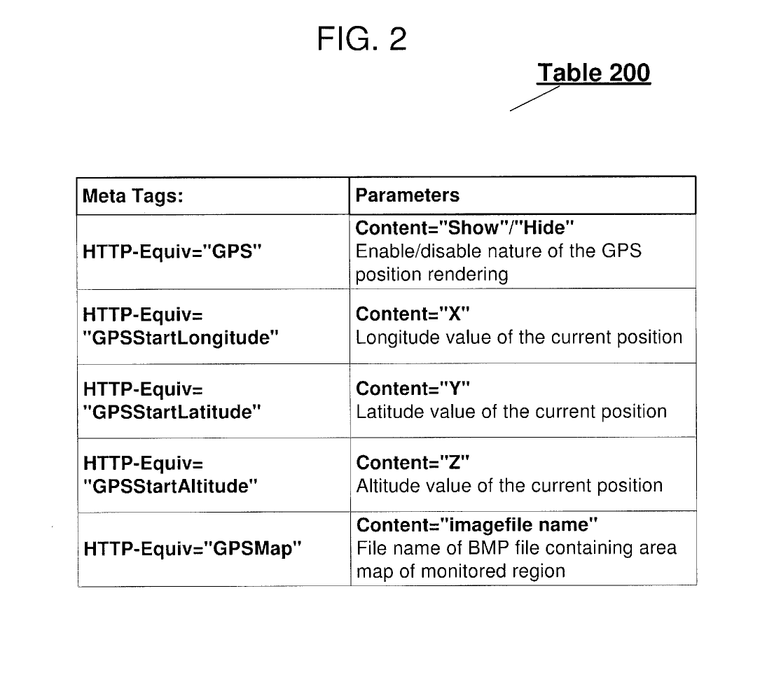

FIG. 2 shows an exemplary table 200 for rendering a change in a GPS position on a web-based document (e.g., a web page) according to the present invention. The table 200 may include a plurality of new Meta tags listed within the HEAD area of an exemplary web page, such as an HTML document. As described above, the Meta tags may be proprietary elements recognized and interpreted by the software tools of the MCD 100. Referring back to FIG. 1, the Meta tags are listed within the table 200 along with a description of the respective contents for each of the tags. Specifically, each of the tags may be in an exemplary format such as: <Meta HTTP-Equiv=“name”; CONTENT=“content”>. Those skilled in the art of web developing would understand that a Meta tag with an “HTTP-Equiv” attribute may be considered equivalent to HTTP headers. Typically, these tags may control the action of browsers, and may be used to refine the information provided by the actual headers. Furthermore, tags using this form should have an equivalent effect when specified as an HTTP header, and in some servers may be translated to actual HTTP headers automatically or by a pre-processing tool.

Exemplary Meta tags may include names such as GPS, GPSStartLongitude, GPSStartLatitude, GPSStartAltitude, and GPSMap. As described in the table 200, the content of the GPS Meta tag may include designations of “Show” and “Hide” wherein the GPS position rendering may be either enabled or disabled, respectively. In addition, the contents of the GPSStartLongitude tag, the GPSStartLatitude tag, and the GPSStartAltitude tag may describe current longitude position, latitude position, and altitude position, respectively, for a point of interest. Furthermore, the content of the GPSMap tag may include a name of image file, such as a BMP file containing an area map.

According to the exemplary embodiments of the present invention, when the Meta tags of FIG. 2 are included within a web page, an image of a corresponding image file (e.g., map1.bmp) may be rendered on the web page starting from a predetermined location, such as, for example, the top left corner of the page. After the rendering, the position of this predetermined location may represent a set of given initial GPS values listed in the respective contents for the GPSStartLongitude tag, the GPSStartLatitude tag, and the GPSStartAltitude tag listed within table 200.

As will be described in greater detail below, while a GPS asset is being monitored over a GPS system, a web browser may re-render the current position of the asset within the corresponding image file, such as the map image 120. Furthermore, the asset may be represented on the web page as a specially colored icon, such as the icon 110. As the altitude of the asset changes, the color and/or the brightness of the icon 110 may change. For example, the color of the icon 110 may intensify or the color may shift up the color spectrum (e.g., from red, to orange, to yellow, etc.) as the altitude increases. Conversely, the color of the icon 110 may weaken or the color may shift down the color spectrum (e.g., from blue, to green, to yellow, etc.) as the altitude decreases.

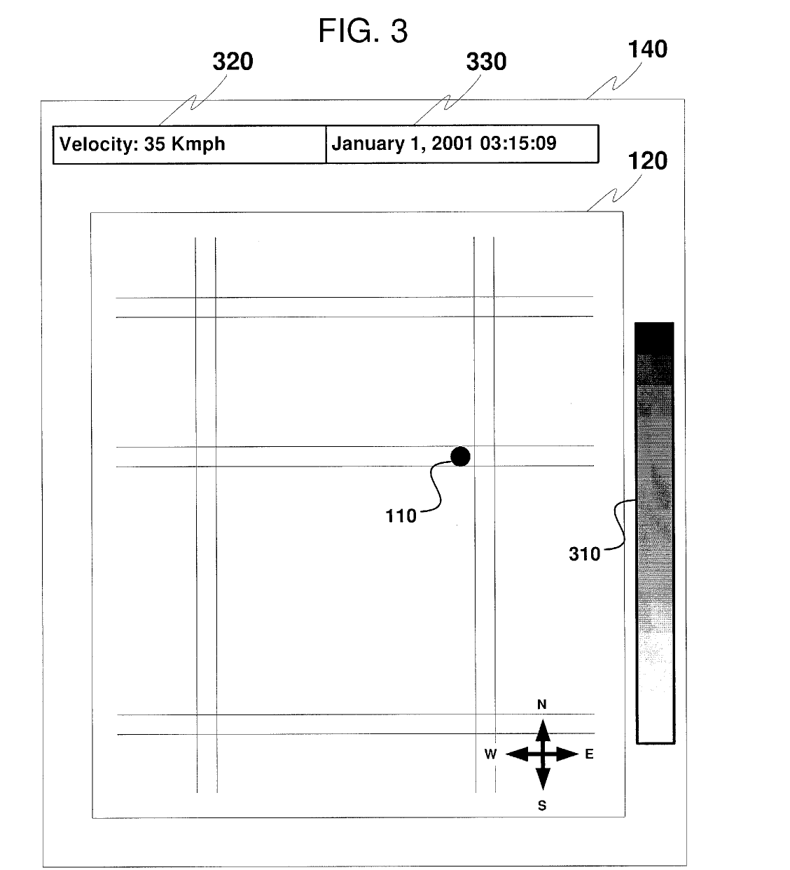

FIG. 3 shows an exemplary display, such as the display 140, for illustrating the changes in direction and altitude of the icon 110 within the map image 120 according to the present invention. The icon 110 may serve as representation of a asset or asset being tracked within a GPS application. As described above, display 140 will be described with reference to the exemplary MCD 100 of FIG. 1. Accordingly, display 140 may include a representation of an altitude measure of the icon 110 via an altimeter 310. The exemplary altimeter 310 may include a grayscale that corresponds to specific measurements. For example, a darker (e.g., black) color may represent a lower (e.g., minimum or zero) altitude measurement, while a brighter (e.g., white) may represent a higher (e.g., maximum) altitude measurement.

While the exemplary embodiments of the display 140 and the icon 110 apply the present invention to illustrating a change in altitude measurements of a tracked GPS asset, the present invention may be used to illustrate a change in any measurable characteristic of the asset, such as, a velocity of the asset. Alternatively, or in addition, measurable characteristics such as velocity may be displayed in a designated location of the display 140 (e.g., a top portion of the display 140). Specifically, the display 140 may further include a speed indicator 320, displaying the current velocity of the tracked GPS asset. The velocity may be calculated based on changes in location data over a measured period of time. Accordingly, the display 140 may also include a date and time indicator 330.

According to the exemplary embodiments of the present invention, the GPS application may receive and interpret location data received from the GPS asset as the asset moves within a monitored region. As described in FIG. 1, this monitored region may be represented on the display 140 by the map image 120 and the GPS asset may be represented on the display 140 by the icon 110. As described above, the map image 120 may be included within a web-based document, such as an HTML or XHTML document, wherein the location data may be inserted into the document through Meta tags. Therefore, a web browser may retrieve the location data and render the current position of the icon 110 within the map image 120 on the display 140.

As noted above, the location data may also include an altitude measurement of the GPS asset. The altitude of the asset may be represented on the display 140 through variations in the icon 110. These variations may include a change in color of the icon 210, a change in brightness of the icon 110, a change in size of the icon 110, etc. Thus, as the browser renders the current position of the icon 110 on the map image 120, the browser may utilize the altitude measurement to configure the appearance of the icon 110. Accordingly, the appearance of the icon 110 may correspond to the altimeter 310 within the display 140. For example, a highest predetermined altitude on the altimeter 310 may be represented by a pure white color while the lowest predetermined altitude (e.g., sea level) may be represented by a black color. Thus, the grey scale on the altimeter 310 may provide an index matching the darkness of the icon 110 to a specific altitude measurement.

Once the initial position and altitude of the GPS asset have been rendered by the web browser onto the map image 120, the browser may receive updated location data from GPS asset. Specifically, the map image 120 may adjust the position of the icon 110 as additional location data is received from the UPS asset. Therefore, as the GPS asset moves within the monitored region, the web browser may re-render the position of the icon 110 within the map image 120. Furthermore, the browser may re-render the respective color of the 210 according to an updated altitude measurement. For example, as the UPS asset goes to a higher altitude, the color of the icon 110 may become whiter. As the browser receives updated data from the UPS asset, the browser may provide a real-time representation of the location and altitude of the asset through rendering changes in the color and position of the icon 110 within the map image 120.

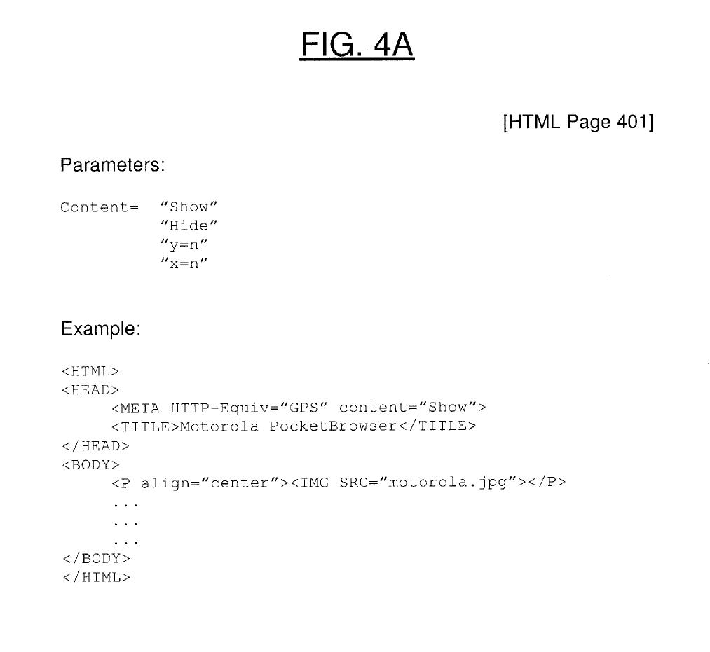

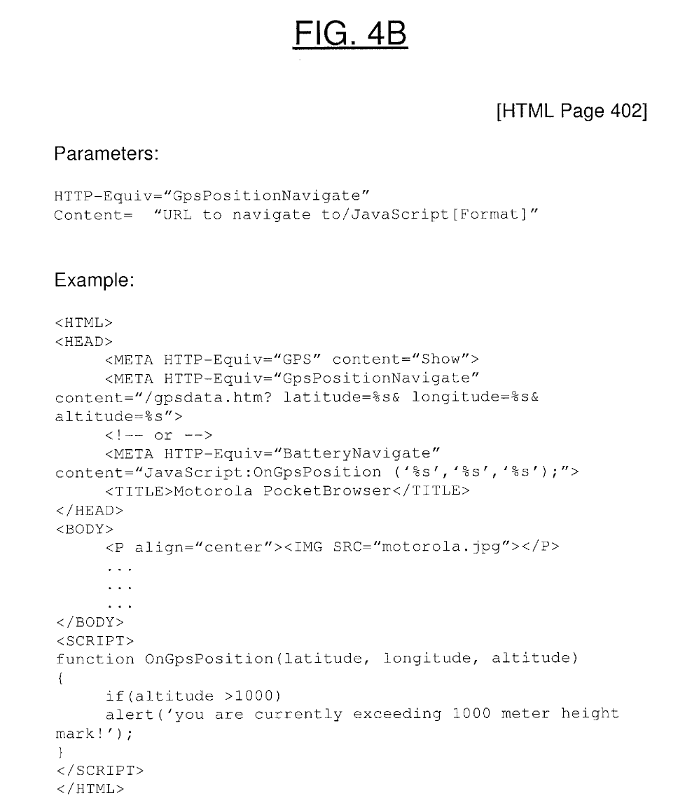

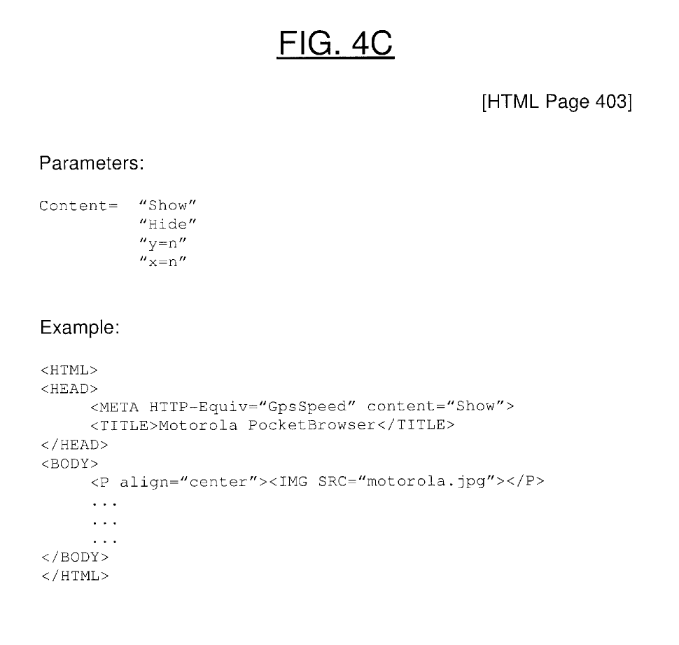

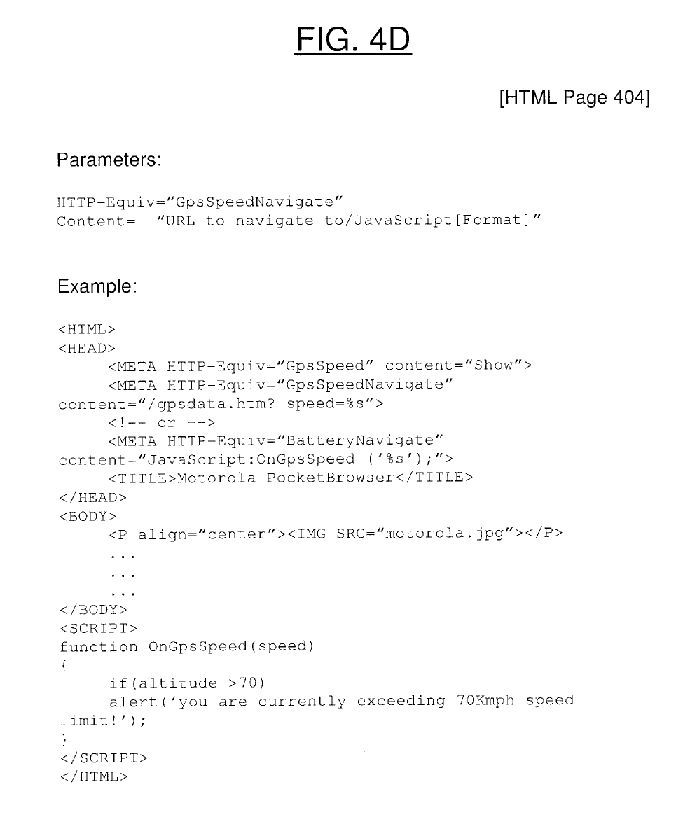

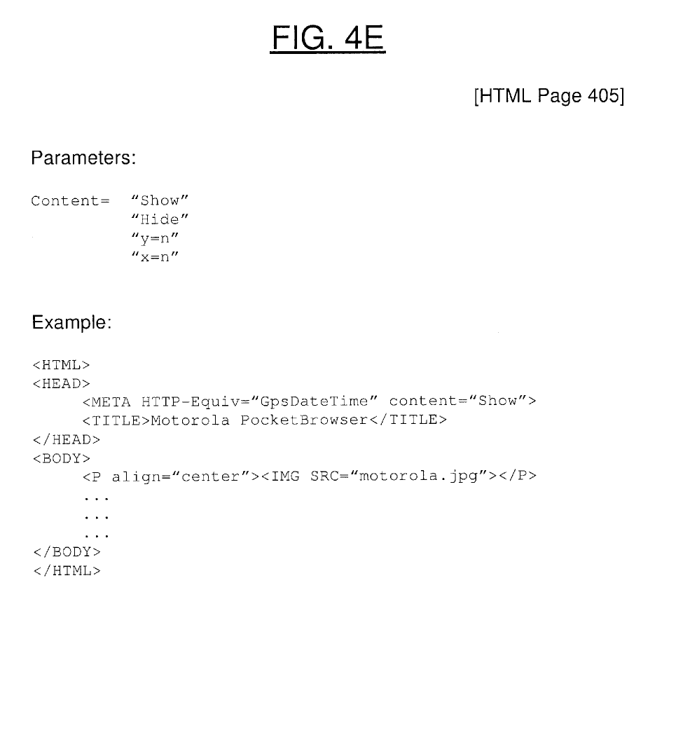

FIG. 4A shows an exemplary web-based document (e.g., HTML page 401) for displaying a UPS position indicator (e.g., icon 120) of a UPS asset on a browser according to the exemplary embodiments of the present invention. Specifically, the HTML page 401 may include content parameters and an example of text for using the Meta tag: Meta HTTP-Equiv=“GPS”. When this Meta tag is implemented, numerical location values (e.g., latitude, longitude, altitude) of the current GPS position may be displayed over the top of the HTML page 401.

Accordingly, an initial position of the UPS indicator may be displayed having a latitude value (e.g., x=n) and a longitude value (e.g., y=n) based on initial location data. In order to change the position of the UPS indicator, additional location data may allow for the HTML page 401 to replace the values of x and y with updated coordinates. The addition of the updated coordinates may change the rendering of the position of the GPS indicator. It should be noted that the parameters of the HTML page 401 may include content designated as “show”, “hide”, “y=n”, and “x=n”, wherein the GPS indicator (e.g., icon 110) may be selectably shown or hidden until directed otherwise. Additional parameters of the HTML page 401 may include an altitude measurement, a velocity, etc.

FIG. 4B shows an exemplary web-based document (e.g., HTML page 402) for displaying position navigation of a GPS asset on a browser according to the exemplary embodiments of the present invention. Specifically, the HTML page 402 may include content parameters and an example of text for using the Meta tag: Meta HTTP-Equiv=“GpsPositionNavigate”. When this Meta tag is implemented, the browser may activate a timer and call either a JavaScript function with current GPS values as parameters or pass the values as a Querystring to a specified page. Accordingly, the GPS location data may be populated into the contents string, thereby replacing ‘% s’ parameters with information such as values for the current latitude, longitude, altitude, etc.

The “GpsPositionNavigate” Meta tag may be page specific, and thus, may only apply on the page that specifies it. In addition, any data stored in a form on the page may not be added to the Querystring. According to one exemplary embodiment, there should be no more than three occurrences of ‘% s’ within the contents field, as this may adversely affect the reliability of the results. Furthermore, a GpsSpeed indicator may be displayed in order for this tag to function. It should be noted that the parameters of the HTML page 401 may include content designated as “URL to navigate to/JavaScript [Format].”

FIG. 4C shows an exemplary web-based document (e.g., HTML page 403) for displaying a speed indicator for a GPS asset on a browser according to the exemplary embodiments of the present invention. Specifically, the HTML page 403 may include content parameters and an example of for using the Meta tag: Meta HTTP-Equiv=“GpsSpeed”. When this Meta tag is implemented, a numerical value of the velocity of the tracked GPS asset may be displayed over the top of the HTML page 403. The velocity may be based on detected changes in the GPS positional values.

Similar to the “GPS” Meta tag, an initial position of the speed indicator may be displayed having a latitude value (e.g., x=n) and a longitude value (e.g., y=n) based on initial location data. In order to change the position of the speed indicator, additional location data may allow for the HTML page 403 to replace the values of x and y with updated coordinates. The addition of the updated coordinates may change the rendering of the position of the speed indicator. It should be noted that the parameters of the HTML page 403 may include content designated as “show”, “hide”, “y=n”, and “x=n”, wherein the speed indicator may be selectably shown or hidden until directed otherwise.

FIG. 4D shows an exemplary web-based document (e.g., HTML page 404) for displaying speed navigation of a GPS asset on a browser according to the exemplary embodiments of the present invention. Specifically, the HTML page 404 may include parameters and an example of for using the Meta tag: Meta HTTP-Equiv=“GpsSpeedNavigate”. When this Meta tag is implemented, the browser may activate a timer and call either a JavaScript function with current moving velocity values as parameters or pass the velocity values as a Querystring to a specified page. Accordingly, the GPS location data may be populated into the contents string, thereby replacing ‘% s’ parameters with the velocity values.

The “GpsSpeedNavigate” Meta tag may be page specific, and thus, may only apply on the page that specifies it. In addition, any data stored in a form on the page may not be added to the Querystring. According to one exemplary embodiment, there should be no more than three occurrences of ‘% s’, within the contents field, as this may adversely affect the reliability of the results. Furthermore, a GpsSpeed indicator may be displayed in order for this tag to function. It should be noted that the parameters of the HTML page 404 may include content designated as “URL to navigate to/JavaScript [Format].”

FIG. 4E shows an exemplary web-based document (e.g., HTML page 405) for displaying a date and time indicator corresponding to a GPS asset on a browser according to the exemplary embodiments of the present invention. Specifically, the HTML page 405 may include parameters and an example of for using the Meta tag: Meta HTTP-Equiv=“GpsDateTime”. When this Meta tag is implemented, a numerical value of the current date and time of the tracked GPS asset may be displayed over the top of the HTML page 405. The date and time may be directly calculated via incoming GPS values (e.g., GPS data string containing special date and time values to calculate total number of milliseconds).

Similar to the “GPS” Meta tag, an initial position of the date and time indicator may be displayed having a latitude value (e.g., x=n) and a longitude value (e.g., y=n) based on initial location data. In order to change the position of the date and time indicator, additional location data may allow for the HTML page 405 to replace the values of x and y with updated coordinates. The addition of the updated coordinates may change the rendering of the position of the date and time indicator. It should be noted that the parameters of the HTML page 405 may include content designated as “show”, “hide”, “y=n”, and “x=n”, wherein the date and time indicator may be selectably shown or hidden until directed otherwise.

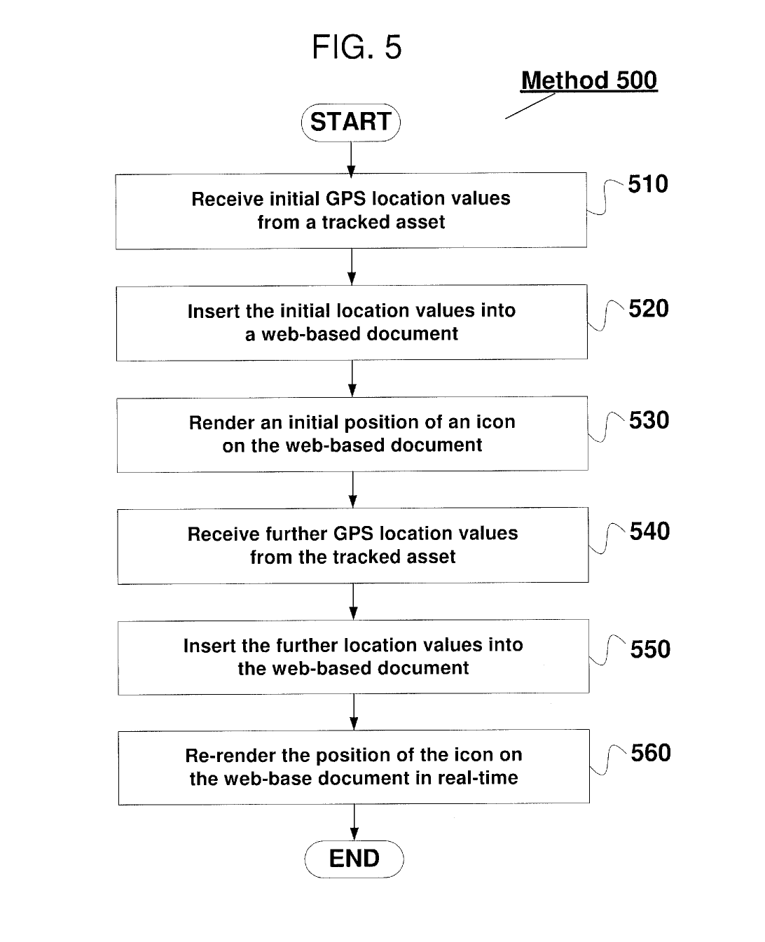

FIG. 5 shows an exemplary method 500 rendering changes in a GPS position of a GPS asset on a web browser according to the exemplary embodiments of the present invention. As described above, the exemplary embodiments of the present invention may be implemented as a feature for a web browser running on a GPS-enabled mobile computer (e.g., MCD 100, a mobile phone, etc.). Accordingly, the exemplary embodiments may employ the use of proprietary Meta tags, or Meta elements, and serve as an extension of web browsing application, such as Motorola pocketBrowser.

In step 510, the method 500 may receive initial GPS location values from an asset. Specifically, the MCD 100 may be in communication with a GPS tracking system, wherein the position of a GPS asset within a monitored region is provided to the MCD 100. One skilled in the art would understand that the location values may be communicated via a wired or wireless communication link. Accordingly, the initial GPS location values may include corresponding latitude value (e.g., x=n) and longitude value (e.g., y=n), as well as an altitude measurement.

In step 520, the method 500 may insert the initial location values into a web-based document. Specifically, the web-based document may include a plurality of Meta tags for inserting the location values in an HTML page. As described above, the Meta tags may include GPSStartLatitude, GPSStartLongitude, and GPSStartAltitude, wherein the respective latitude, longitude, and altitude values may be inserted.

In step 530, the method 500 may render an initial position of an icon on the web-based document, wherein the icon represents a location on the asset within the monitored region. Specifically, the web-based document may include at least one Meta tag for inserting a map image into an HTML page. As described above, the Meta tag may be GPSMap, wherein the content of the GPSMap may direct the browser to a specific image file, such as map1.bmp. Accordingly, the browser may use the x and y values to render a representation of the GPS asset onto a display. The x and y values may represent a distance from a predetermined position within the map (e.g., the top left corner of the map image). Furthermore, the browser may render the color and/or brightness of the icon in relation to the altitude measurement of the GPS asset. Accordingly, the color or brightness of the icon may be indexed using a corresponding altimeter having predetermined colors or brightness representing changes in the measured altitude.

In step 540, the method 500 may receive further GPS location values from the asset. In other words, the browser may receive updated values for the latitude, longitude, and altitude of the GPS asset. As described above, these values may be communicated to the MCD 100 via a GPS tracking device.

In step 550, the method 500 may insert the further location values into the web-based document. Specifically, the browser may update the values within the GPSStartLatitude, GPSStartLongitude, and GPSStartAltitude Meta tags. Finally, in step 560, the method 500 may re-render the position of the icon on the web-base document in real-time. Thus, while the movement of the GPS asset is tracked, the browser will re-render the representation of the current position and altitude of the asset within the map image.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
receiving initial location values of an asset within a monitored region;
inserting the initial location values into a web-based document; and
rendering an initial position of an icon on the web-based document, wherein the icon represents a location of the asset within the monitored region on a display.

2. The method of claim 1, further comprising:
receiving further location values from the asset;
inserting the further location values into the web-based document; and
rendering a current position of the icon on the web-based document.

3. The method of claim 1, wherein the web-based document is writing in one of HyperText Markup Language (“HTML”), JavaScript, Extensible Markup Language (“XML”), Asynchronous JavaScript and XML (“AJAX”), and Cascading Style Sheets (“CSS”).

4. The method of claim 2, wherein the web-based document includes a plurality of Meta tags specifying the initial and current location values of the asset within the display.

5. The method of claim 2, wherein the initial and current location values include at least one of a latitude value, a longitude value, and an altitude value.

6. The method of claim 5, wherein the altitude value is represented by one of a predetermined color and a predetermined brightness level of the icon on the web-based document.

7. A device, comprising:
a communication interface receiving initial location values of an asset within a monitored region a display displaying an image of the monitored region; and
a processor inserting the initial location values into a web-based document and rendering an initial position of an icon on the web-based document, wherein the icon represents a location of the asset within the monitored region.

8. The device of claim 7, wherein the communication interface receives further location values from the asset, and the processor inserts the further location values into the web-based document and renders a current position of the icon on the web-based document.

9. The device of claim 7, wherein the web-based document is writing in one of HyperText Markup Language (“HTML”), JavaScript, Extensible Markup Language (“XML”), Asynchronous JavaScript and XML (“AJAX”), and Cascading Style Sheets (“CSS”).

10. The device of claim 8, wherein the web-based document includes a plurality of Meta tags specifying the initial and current location values of the asset within the display.

11. The device of claim 8, wherein the initial and current location values include at least one of a latitude value, a longitude value, and an altitude value.

12. The device of claim 11, wherein the altitude value is represented by one of a predetermined color and a predetermined brightness level of the icon on the web-based document.

13. A system, comprising:
a receiving means receiving initial location values of an asset within a monitored region;
an inserting means inserting the initial location values into a web-based document; and
a rendering means rendering an initial position of an icon on the web-based document, wherein the icon represents a location of the asset within the monitored region on a display.

14. The system of claim 13, wherein the receiving means receives further location values from the asset; and the inserting means inserts the further location values into the web-based document; and the rendering means renders a current position of the icon on the web-based document.

15. The system of claim 13, wherein the web-based document is writing in one of HyperText Markup Language (“HTML”), JavaScript, Extensible Markup Language (“XML”), Asynchronous JavaScript and XML (“AJAX”), and Cascading Style Sheets (“CSS”).

16. The system of claim 14, wherein the web-based document includes a plurality of Meta tags specifying the initial and current location values of the asset within the display.

17. The system of claim 14, wherein the initial and current location values include at least one of a latitude value, a longitude value, and an altitude value.

18. The system of claim 17, wherein the altitude value is represented by one of a predetermined color and a predetermined brightness level of the icon on the web-based document.
